(19) United States
(12) Patent Application Publication
(10) Pub. No.: US 2026/0019517 A1
(43) Pub. Date: Jan. 15, 2026

(54) DOCUMENT CONVEYANCE APPARATUS, IMAGE READING APPARATUS, AND IMAGE FORMING APPARATUS

(71) Applicant: CANON KABUSHIKI KAISHA, Tokyo (JP)

(72) Inventor: KAORU HAMADA, Chiba (JP)

(21) Appl. No.: 19/249,880

(22) Filed: Jun. 25, 2025

(30) Foreign Application Priority Data
Jul. 10, 2024 (JP) 2024-111309

(51) Int. Cl. H04N 1/00; G03G 15/00; G03G 15/22

(52) U.S. Cl. CPC H04N 1/00777; G03G 15/228; G03G 15/5016; G03G 15/602; G03G 15/607; H04N 1/00702; H04N 1/00729; H04N 1/00771; H04N 1/00824; H04N 2201/0094

(57) ABSTRACT

A document conveyance apparatus includes a document tray, a separation feeding unit configured to form a separation nip for separating the documents one by one and to feed a document, a detection sensor configured to detect the document, a controller configured to stop feeding of the document based on the detection sensor, an environment sensor configured to acquire environment information, and a display. When the controller stops feeding of the document, (a) in a case where the environment information acquired by the environment sensor satisfies a predetermined condition, the display displays a screen for prompting a user to loosen a bundle of documents, and (b) in a case where the environment information acquired by the environment sensor does not satisfy the predetermined condition, the display does not display the screen for prompting the user to loosen the bundle of documents.

### BACKGROUND

### Field of the Technology

The present disclosure relates to a document conveyance apparatus that conveys documents, and an image reading apparatus and an image forming apparatus that include the document conveyance apparatus.

### Description of the Related Art

Image forming apparatuses such as a copying machine, a facsimile apparatus, and a complex machine include an image reading apparatus for reading an image from a document. The image reading apparatus includes an auto-document conveyance apparatus (hereinafter, referred to an auto-document feeder (ADF)) for reading a plurality of documents continuously. The above-described image forming apparatus can read images of documents while conveying the documents by the ADF.

The ADF separates and conveys a plurality of documents one by one. However, in a case where the documents are adhered to each other because of static electricity, a paper jam (also called “jam”) is likely to occur because the ADF cannot separate the documents. In contrast, Japanese Patent Application Laid-Open No. 2017-52593 discusses an ADF having a double-feeding sensor for detecting documents in a double feeding state.

Depending on the environment (a temperature and a humidity) where the apparatus is installed, however, many documents can be adhered to each other and cannot be fed from a document tray. In this case, the apparatus determines occurrence of a jam in a state where no document has reached the double-feeding sensor.

Even if feeding is restarted in the above-described state, there has been an issue that jams repeatedly occur because adhesion of documents has not been cleared, accordingly.

### SUMMARY

The present disclosure is directed to a document conveyance apparatus, an image reading apparatus, and an image forming apparatus, capable of notifying a user of appropriate processing in a case where adhesion of documents occurs.

According to an aspect of the present disclosure, a document conveyance apparatus includes a document tray on which documents are stacked, a separation feeding unit configured to form a separation nip for separating the documents stacked on the document tray one by one and to feed a document separated by the separation nip in a feeding direction, a detection sensor configured to detect the document at a position downstream of the separation nip in the feeding direction, a controller configured to stop feeding of the document executed by the separation feeding unit, in a case where the detection sensor does not detect the document within a predetermined time after the separation feeding unit starts feeding of the document, an environment sensor configured to acquire environment information including at least any one of a temperature and a humidity, and a display. When the controller stops feeding of the document based on the detection sensor, (a) in a case where the environment information acquired by the environment sensor satisfies a predetermined condition, the display displays a screen for prompting a user to loosen a bundle of documents, and (b) in a case where the environment information acquired by the environment sensor does not satisfy the predetermined condition, the display does not display the screen for prompting the user to loosen the bundle of documents.

Further features of the present disclosure will become apparent from the following description of exemplary embodiments with reference to the attached drawings.

### BRIEF DESCRIPTION OF THE DRAWINGS

FIG. 1 is a cross-sectional diagram of an image forming apparatus.

FIG. 2 is a perspective diagram of an image reading apparatus.

FIG. 3 is a cross-sectional diagram of the image reading apparatus.

FIG. 4 is a diagram illustrating a front view of an operation unit included in the image reading apparatus.

FIG. 5 is a block diagram of the image forming apparatus.

FIG. 6 is a flowchart illustrating feeding-reading control processing executed by a reader controller according to one or more aspects of the present disclosure.

FIG. 7 is a flowchart illustrating feeding-reading control processing executed by a system controller according to one or more aspects of the present disclosure.

FIG. 8A is a diagram illustrating an example of a condition for making a determination of an environment where adhesion of documents is likely to occur. FIG. 8B is a diagram illustrating another example of a condition for making a determination of an environment where adhesion of documents is likely to occur.

FIG. 9 is a diagram illustrating an example of an operation screen displayed when a job is input.

FIG. 10 is a diagram illustrating an example of a jam clearance screen displayed when a jam has occurred.

FIG. 11 is a diagram illustrating an example of a document loosening screen displayed when a jam has occurred.

FIG. 12 is a diagram illustrating an example of a document resetting screen displayed when a jam has occurred.

FIG. 13 is a flowchart illustrating feeding-reading control processing executed by a reader controller according to one or more aspects of the present disclosure.

### DESCRIPTION OF THE EMBODIMENTS

Hereinafter, exemplary embodiments of the present disclosure will be described with reference to the appended drawings.

### Image Forming Apparatus

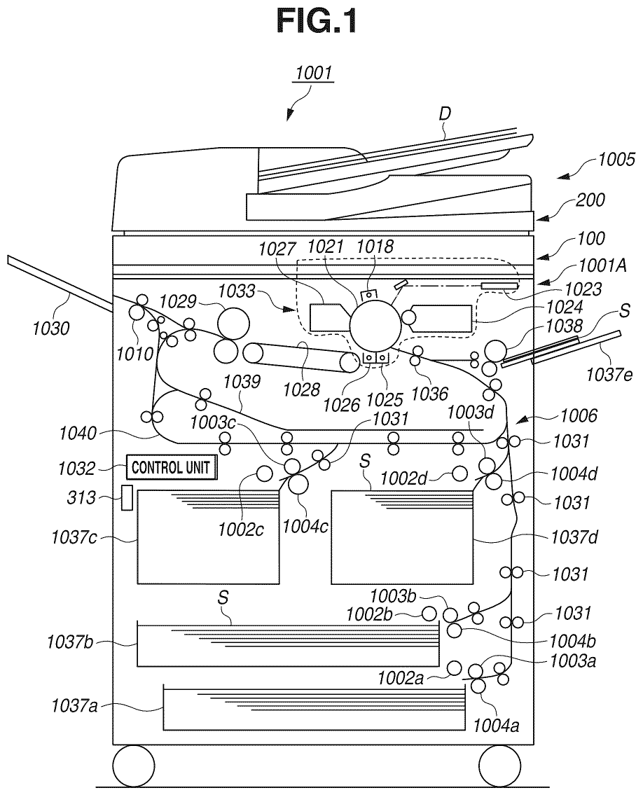

FIG. 1 is a diagram illustrating a configuration of an image forming apparatus including an image reading apparatus according to a firsts exemplary embodiment. An image reading apparatus 1005 is mounted on top of a printer 1001A serving as a main body of an image forming apparatus 1001. For example, the image forming apparatus 1001 can be implemented by a copying machine, a facsimile apparatus, or a multi-functional peripheral (MFP). The image forming apparatus 1001 includes the below-described operation unit 90 serving as a user interface including an input interface and an output interface.

The image reading apparatus 1005 includes a scanner unit 100 and an ADF 200 for automatically conveys documents D. The ADF 200 is one example of the document conveyance apparatus. The ADF 200 is mounted on the scanner unit 100 in an openable/closable manner. The scanner unit 100 optically scans a document D to read an image from the document D. The image reading apparatus 1005 transmits image data describing a read image of the document D to a control unit 1032 of the printer 1001A. According to the control executed by the control unit 1032, the printer 1001A forms an image based on the acquired image data on a sheet S serving as a recording medium. In other words, the printer 1001A can form an image on the sheet S based on an image of the document D read by the image reading apparatus 1005.

The printer 1001A includes an image forming unit 1033 for forming an image on a sheet S, a sheet feeding unit 1006 for feeding the sheet S to the image forming unit 1033, and a fixing device 1029.

The sheet S is conveyed from the sheet feeding unit 1006 to the image forming unit 1033, so that an image is transferred to the sheet S. Thereafter, the image is fixed on the sheet S by the fixing device 1029, and the sheet S is discharged to a discharge tray 1030.

The sheet feeding unit 1006 includes a plurality of sheet storage units 1037a, 1037b, 1037c, and 1037d, each of which can store sheets S in different sizes. The sheets S stored in the sheet storage units 1037a, 1037b, 1037c, and 1037d are fed from the sheet storage units 1037a, 1037b, 1037c, and 1037d by corresponding pick-up rollers 1002a, 1002b, 1002c, and 1002d, respectively. Each of the fed sheets S is separated one by one and conveyed to corresponding conveyance roller pairs 1031 by corresponding feeding rollers 1003a, 1003b, 1003c, and 1003d, and retard rollers 1004a, 1004b, 1004c, and 1004d. Each of the sheets S is conveyed to a registration roller pair 1036 arranged on a sheet conveyance path by being sequentially forwarded to a plurality of conveyance roller pairs 1031 arranged along the sheet conveyance path.

The sheet feeding unit 1006 also has a manual sheet feeding tray 1037e. A sheet S places by the user on the manual sheet feeding tray 1037e is fed to the inner portion of the printer 1001A by a sheet feeding roller pair 1038, and conveyed to the registration roller pair 1036.

The registration roller pair 1036 stops a leading end of the sheet S, and corrects skewing of the sheet S. The registration roller pair 1036 starts conveying the sheet S to the image forming unit 1033 again according to progress of the processing of forming a toner image executed by the image forming unit 1033.

The image forming unit 1033 according to the present exemplary embodiment is an electrophotographic apparatus including a photosensitive drum 1021. The image forming unit 1033 can be an apparatus to form an image through another method such as an ink jet method or an offset printing method.

The photosensitive drum 1021 is a drum-shaped photosensitive member having a photosensitive layer on its surface. The photosensitive drum 1021 can rotate about a drum axis in a direction along the conveyance direction of the sheet S. In the periphery of the photosensitive drum 1021, a charging device 1018, an exposure device 1023, a development device 1024, a transfer charging device 1025, a separation charging device 1026, and a cleaner 1027 are arranged. The charging device 1018 uniformly charges the surface of the photosensitive drum 1021. The exposure device 1023 exposes the charged surface of the photosensitive drum 1021 with light to form an electrostatic latent image on the photosensitive drum 1021 based on image data acquired from the image reading apparatus 1005 or an external apparatus.

The development device 1024 stores two-component developer including toner and carriers. The development device 1024 supplies charged toner to the photosensitive drum 1021 to make toner adhere to the electrostatic latent image. Through the above operation, the electrostatic latent image is developed, so that a toner image is formed on the surface of the photosensitive drum 1021. The toner image born on the photosensitive drum 1021 is transferred to a sheet S by a bias electric field formed by the transfer charging device 1025. The sheet S is conveyed to the transfer charging device 1025 from the registration roller pair 1036 at a timing when the toner image is formed.

The sheet S on which the toner image is transferred is separated from the photosensitive drum 1021 by the bias electric field formed by the separation charging device 1026, and conveyed to the fixing device 1029 by a pre-fixation conveyance unit 1028. Adhered substance such as transfer residual toner, remaining in the photosensitive drum 1021 without being transferred to the sheet S, is removed by the cleaner 1027. The photosensitive drum 1021 can thus be ready to perform next image forming operation.

The fixing device 1029 conveys the sheet S by holding the sheet S with the roller pair. At this time, the fixing device 1029 applies heat and pressure to the sheet S to cause the toner image to be melted and fixed to the sheet S. Formation of the image on the sheet S is completed when the toner image is fixed to the sheet S. The sheet S on which the image is formed is discharged to a discharge tray 1030 projected on the outer side of the printer 1001A via a discharge roller pair 1010.

In a case where two-sided printing is executed, the sheet S having an image formed on one face (first face) is conveyed to an inversion unit 1039 after passing through the fixing device 1029 so that an image is formed on another face (second face) thereof. After an image forming face is inverted to the second face from the first face by the inversion unit 1039, the sheet S is conveyed to a two-sided conveyance unit 1040. The two-sided conveyance unit 1040 conveys the sheet S, whose image forming face is inverted, to the registration roller pair 1036. The sheet S is conveyed from the registration roller pair 1036 to the image forming unit 1033, so that an image is formed on the second face. Thereafter, the sheet S is discharged to the discharge tray 1030.

The printer 1001A also includes an environment sensor unit 313. The environment sensor unit 313 is an environment acquisition unit to acquire information about a peripheral environment where the image forming apparatus 1001 is installed. The environment sensor unit 313 includes a temperature sensor 313a and a humidity sensor 313b described below. The environment sensor unit 313 can acquire a temperature and a humidity of the environment where the image forming apparatus 1001 is installed. The printer 1001A can control an image forming condition of the image forming unit 1033 based on the environment information acquired by the environment sensor unit 313. For example, the printer 1001A controls a fixing temperature of the fixing device 1029 based on the environment information acquired by the environment sensor unit 313. The image forming apparatus 1001 can thereby form an image with an image forming condition appropriate for the peripheral environment condition of a site where the image forming apparatus 1001 is installed. However, the environment sensor unit 313 may have at least any one of the temperature sensor 313a and the humidity sensor 313b, so that the environment sensor unit 313 can acquire the environment information including at least any one of a temperature and a humidity.

### Image Reading Apparatus

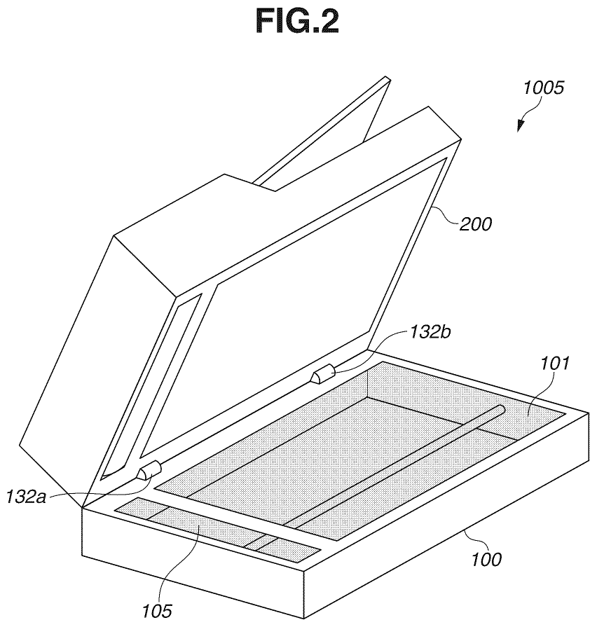

FIG. 2 is a perspective diagram illustrating an external view of the image reading apparatus 1005. The ADF 200 is mounted on the scanner unit 100 by hinges 132a and 132b in an openable/closable manner. FIG. 2 illustrates a state where the ADF 200 opens to the scanner unit 100. The scanner unit 100 has a built-in controller described below. The controller controls the operation executed by the image reading apparatus 1005.

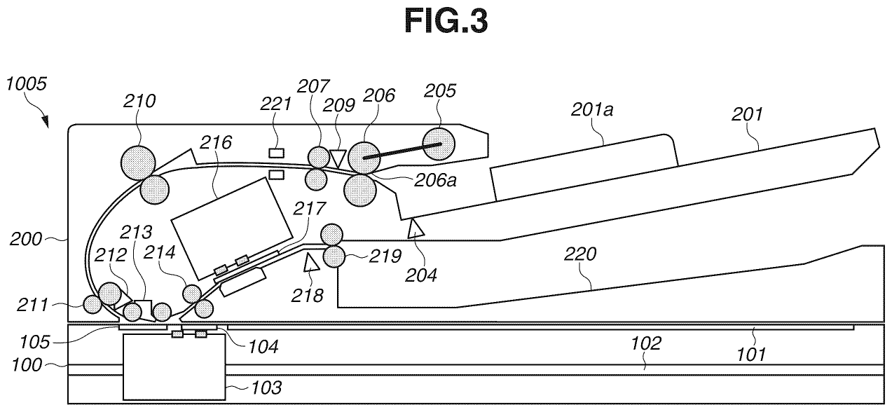

FIG. 3 is a diagram illustrating a configuration of the image reading apparatus 1005. The scanner unit 100 includes a document positioning glass plate 101, a front face feeding-reading glass 105, and a white-color reference plate 104, which are arranged on an upper face of the scanner unit 100, and includes a front face reading unit 103 and a moving guide 102 built into the scanner unit 100. The front face reading unit 103 reads an image of one face (front face) of a document. The front face reading unit 103 can be moved along the moving guide 102 in a sub-scanning direction (i.e., right-left direction in FIG. 3) by an optical motor described below.

In a case where a document D conveyed by the ADF 200 is read, the front face reading unit 103 is stopped at a position on the lower side of the front face feeding-reading glass 105, and executes image reading processing by reading an image of the conveyed document D line by line. The processing for reading documents D while conveying the documents D by the ADF 200 is referred to as “feeding-reading” processing. In a case where a document D placed on the document positioning glass plate 101 is read, the front face reading unit 103 executes image reading processing by reading an image of the document D line by line while moving along the moving guide 102 in the sub-scanning direction. The processing for reading a document D placed on the document positioning glass plate 101 is referred to as “fixed-reading” processing. The white-color reference plate 104 is read by the front face reading unit 103 when the front face reading unit 103 executes shading correction. The white-color reference plate 104 is arranged between the document positioning glass plate 101 and the front face feeding-reading glass 105.

The ADF 200 includes a document tray 201 on which sheet-like documents D are stacked. The ADF 200 is a sheet conveyance apparatus to convey a document D to a reading position where the scanner unit 100 reads an image from the document D. The ADF 200 conveys a document D placed on the document tray 201 to a discharge tray 220 via a conveyance path. On the document tray 201, a plurality of documents D can be placed. The document tray 201 includes two side regulation plates 201a arranged in a direction orthogonal to the conveyance direction of the document D. The two side regulation plates 201a can be moved in a width direction orthogonal to the conveyance direction. The side regulation plates 201a regulate the movement of the document D in a direction orthogonal to the conveyance direction by holding the document D placed on the document tray 201. In below descriptions, an upstream side and a downstream side are specified based on the conveyance direction of the document D, and one side the document D is conveyed from is the upstream side, whereas another side the document D is conveyed to is the downstream side.

The ADF 200 can consecutively convey the documents D to the conveyance path one by one. On the conveyance path, various rollers for conveying a document D and sensors for detecting the document D are arranged. The conveyance path has a separation roller pair 206 and a pick-up roller 205 serving as separation mechanisms. The separation roller pair 206 regulates the documents D to prevent the documents D from projecting from and moving out of the document tray 201 in a downstream direction before conveyance is started. On the document tray 201, a document detection sensor 204 for detecting presence and absence of a document D on the document tray 201 is arranged.

The pick-up roller 205 falls onto the uppermost face of a bundle of documents D stacked on the document tray 201, and rotates to feed the uppermost document D in a feeding direction. The separation roller pair 206 forms a separation nip 206a for separating a document D, and separates and conveys the uppermost document D fed by the pick-up roller 205. The document D is separated by a known separation technique. For example, the separation roller pair 206 separates the document D by making the two rollers rotate in the opposite direction. The pick-up roller 205 and the separation roller pair 206 are driven by a same driving source. The separation roller pair 206 conveys the document D to a pull-out roller pair 207. The pick-up roller 205 and the separation roller pair 206 are examples of the elements that constitute a separation feeding unit for separating and feeding a document D in a feeding direction. The separation feeding unit may include not only rollers such as the pick-up roller 205 and the separation roller pair 206, but also another rotation member such as a belt.

The separation roller pair 206 may include separation pads which form the separation nip 206a together with the rollers.

A separation sensor 209 is arranged downstream of the separation roller pair 206 in the feeding direction.

Based on a timing when a leading end of the document D is detected by the separation sensor 209, the pull-out roller pair 207 starts conveying the document D, and rotation of the pick-up roller 205 and the separation roller pair 206 is stopped. Specifically, the rotation of the pick-up roller 205 and the separation roller pair 206 is stopped at a timing when the document D reaches the pull-out roller pair 207 by being conveyed by a predetermined distance after a leading end of the document D is detected by the separation sensor 209. Thereafter, the document D is conveyed by the pull-out roller pair 207, a conveyance roller pair 210, and a read upstream roller pair 211 in this order. Similarly to the registration roller pair 1036, the conveyance roller pair 210 can also correct skewing of the document D. The read upstream roller pair 211 conveys the document D to the front face feeding-reading glass 105.

A double-feeding sensor 221 is arranged downstream of the separation roller pair 206. Double-feeding is a phenomenon in which two documents D pass through the separation nip 206a together in a double feeding state where the two documents D are adhered to each other. When double-feeding occurs, abnormalities such as a skip-over and a jam of the documents D occur. The double-feeding sensor 221 is an ultrasonic sensor consisting of an ultrasonic wave emission unit and an ultrasonic wave reception unit arranged to face each other with a conveyance path therebetween. When the document D passes the double-feeding sensor 221, the double-feeding sensor 221 emits an ultrasonic wave to the document D. The double-feeding sensor 221 then receives the ultrasonic wave passing through the document D. In this way, the double-feeding sensor 221 can detect whether the document D is fed in a double feeding state based on the intensity of the received ultrasonic wave. A central processing unit (CPU) 301 described below stops feeding the documents D when the double-feeding sensor 221 detects documents D fed in a double feeding state. In the present exemplary embodiment, the double-feeding sensor 221 is arranged between the pull-out roller pair 207 and the conveyance roller pair 210 in the conveyance direction. However, the double-feeding sensor 221 can be arranged at any position downstream of the separation nip 206a formed by the separation roller pair 206. For example, the double-feeding sensor 221 can be arranged between the separation roller pair 206 and the pull-out roller pair 207.

On the upstream of the front face feeding-reading glass 105, a read sensor 212 is arranged. In a case where a front face of a document D is read, the front face reading unit 103 starts reading the document D at a timing when a leading end of the document D is detected by the read sensor 212. On the front face feeding-reading glass 105, a document press-down member 213 is arranged. The document D is read by the front face reading unit 103 while the document D is passing through a space between the front face feeding-reading glass 105 and the document press-down member 213. A position of the front face feeding-reading glass 105 is a reading position where the document D is read by the front face reading unit 103.

The document D that has passed the reading position of the front face reading unit 103 is conveyed by a read downstream roller pair 214. A back face feeding-reading glass 217 is arranged downstream of the read downstream roller pair 214. A back face reading unit 216 for reading an image of another face (back face) of the document D is arranged on one side of the back face feeding-reading glass 217 opposite to another side thereof where the conveyance path is located. When the document D is conveyed by the read downstream roller pair 214 to pass through a space between the back face feeding-reading glass 217 and the conveyance path, an image of the back face is read by the back face reading unit 216. In a case where the back face of the document D is read, the back face reading unit 216 starts reading the document D at a timing when a leading end of the document D is detected by the read sensor 212. A position of the back face feeding-reading glass 217 is a reading position where the back face is read.

After the image of the back face is read, the document D is discharged to the discharge tray 220 by a discharge roller pair 219. In a case where only an image of the front face is read, image reading processing is not executed by the back face reading unit 216. Thus, the document D passes through the reading position of the back face reading unit 216, and is discharged to the discharge tray 220 after image reading processing is executed by the front face reading unit 103. A discharge sensor 218 is arranged at a position between the back face feeding-reading glass 217 and the discharge roller pair 219. In a case where no document D is present at the document tray 201, rotation of the respective rollers for conveying a fed document D is stopped at a timing when a trailing end of the document D is detected by the discharge sensor 218 after the document D is discharged completely. In other words, the pull-out roller pair 207, the conveyance roller pair 210, the read upstream roller pair 211, the read downstream roller pair 214, and the discharge roller pair 219 stop rotating.

In the present exemplary embodiment, a configuration of the front face reading unit 103 is same as a configuration of the back face reading unit 216. Each of the front face reading unit 103 and the back face reading unit 216 includes a light emitting unit, an optical system such as a lens array, and a light receiving unit. In the present exemplary embodiment, a light emitting diode (LED) is used as the light emitting unit, and a line sensor is used as the light receiving unit. For example, the line sensor is implemented by a contact image sensor (CIS) or a charge coupled device (CCD) sensor configured of a reduced optical system using a mirror. The line sensor is arranged in a width direction of the document D. Thus, a width direction of a document D is a main scanning direction of the front face reading unit 103 and the back face reading unit 216, and a conveyance direction of the document D is a sub-scanning direction of the front face reading unit 103 and the back face reading unit 216.

The front face reading unit 103 irradiates a document D passing through the front face feeding-reading glass 105 (front face reading position) with light emitted from the LED. The light emitted from the LED is reflected on the front face of the document D. The light reflected on the front face of the document D is formed into an image on a light receiving face of the line sensor through the optical system. The line sensor outputs image data expressing an image of the front face of the document D according to the reflected light formed into the image. As described above, the front face reading unit 103 executes image reading processing of the front face of the document D.

In a case where two-sided reading of the document D is specified, the back face reading unit 216 executes image reading processing.

The back face reading unit 216 irradiates the document D passing through the back face feeding-reading glass 217 (back face reading position) with light emitted from the LED. The light emitted from the LED is reflected on the back face of the document D. The light reflected on the back face of the document D is formed into an image on a light receiving face of the line sensor through the optical system. The line sensor outputs image data expressing an image of the back face of the document D according to the reflected light formed into the image. As described above, the back face reading unit 216 executes image reading processing of the back face of the document D. In addition, the configurations of the front face reading unit 103 and the back face reading unit 216 can be different from each other.

### Operation Unit

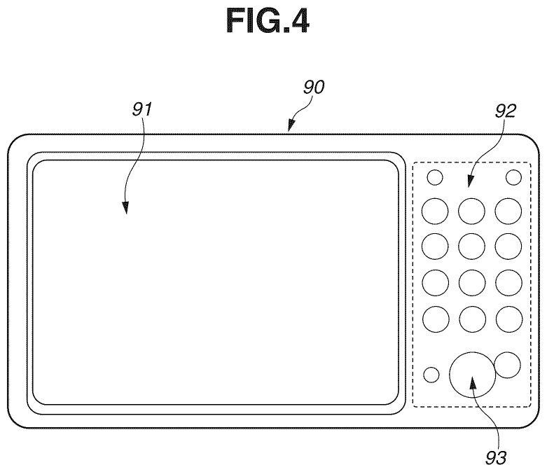

Next, the operation unit 90 included in the image forming apparatus 1001 will be described. FIG. 4 is a diagram illustrating a top plan view of the operation unit 90. The operation unit 90 is arranged on a front side of the scanner unit 100, and accepts the operation performed by the user. The operation unit 90 includes a display 91 serving as a display unit for displaying information to the user, a keypad 92 including a plurality of hard keys, and a start button 93. The display 91 is a touch panel to display information to the user, and allows the user to perform operations by touching the display 91 with a finger. The user can input various instructions and settings such as a reading start instruction and a print setting via the operation unit 90.

### Controller

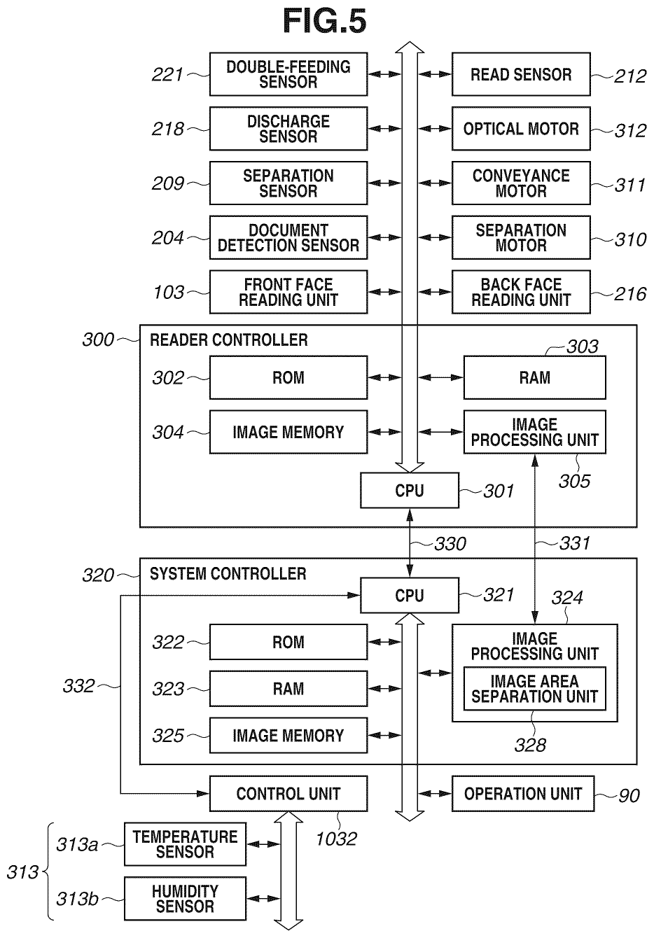

FIG. 5 is a block diagram illustrating a configuration of a controller included in the image reading apparatus 1005. The controller (control unit) includes a reader controller 300 and a system controller 320. The reader controller 300 is arranged inside the scanner unit 100. The system controller 320 is arranged inside the scanner unit 100 or the printer 1001A. The reader controller 300 and the system controller 320 are communicably connected to each other via a command data bus 330 and an image data bus 331.

The reader controller 300 is an information processing apparatus that includes a central processing unit (CPU) 301, a read only memory (ROM) 302, and a random access memory (RAM) 303. The CPU 301 controls the entire operation executed by the image reading apparatus 1005 by executing a computer program stored in the ROM 302. The RAM 303 provides a work area when the CPU 301 executes processing. The CPU 301 is connected with an image memory 304 and an image processing unit 305.

The CPU 301 is connected with motors and sensors arranged on the respective units included in the image reading apparatus 1005, the front face reading unit 103, and the back face reading unit 216. The motors include the separation motor 310, the conveyance motor 311, and the optical motor 312. The separation motor 310 is a driving source that rotationally drives the pick-up roller 205 and the separation roller pair 206 to feed documents D to the conveyance path one by one. The conveyance motor 311 is a driving source of respective rollers for conveying the documents D to the conveyance path, e.g., the pull-out roller pair 207, the conveyance roller pair 210, the read upstream roller pair 211, the read downstream roller pair 214, and the discharge roller pair 219. The optical motor 312 is a driving source to move the front face reading unit 103 along the moving guide 102. The sensors include the document detection sensor 204, the separation sensor 209, the read sensor 212, the discharge sensor 218, and the double-feeding sensor 221.

The operations executed by the motors, the sensors, the front face reading unit 103, and the back face reading unit 216 are as described above. The CPU 301 stores image data output from the front face reading unit 103 and the back face reading unit 216 in the image memory 304. According to an image output request acquired from the system controller 320 via the command data bus 330, the CPU 301 causes the image processing unit 305 to execute various types of image processing on the stored image data, and transmits the image data to the system controller 320 via the image data bus 331. The CPU 301 also notifies the system controller 320 of a vertical synchronization signal used as a reference for a leading end of a read image and a horizontal synchronization signal used as a reference for a leading end of one line of pixels of the read image via the image data bus 331, according to a reading timing of a document.

The system controller 320 is an information processing apparatus that includes a CPU 321, a ROM 322, a RAM 323, an image processing unit 324, and an image memory 325. The image processing unit 324 includes an image area separation unit 328. The CPU 321 is communicably connected to the CPU 301 of the reader controller 300 via the command data bus 330, so that the CPU 321 cooperates with the CPU 301 to execute transmission and reception of data related to the image reading processing. The CPU 321 is also connected to the operation unit 90 described above, so that the CPU 321 can accept operations performed by the user.

The CPU 321 transmits an image output request to the reader controller 300. The CPU 321 causes, according to the image output request, the image processing unit 324 to execute various types of image processing on the image data acquired from the reader controller 300 via the image data bus 331. After the image processing is executed on the image data, the image data is stored in the image memory 325. The image area separation unit 328 executes image area separation processing when the image data having been processed by the image processing is stored in the image memory 325.

The image area separation processing is executed as follows. The image area separation unit 328 detects an area where text is formed (text area) and an area where graphics other than text are formed (picture area) from the image expressed by the image data. The text area and the picture area are combined to form a content area where content of a document D is formed. Based on a detected content area, the image processing unit 324 executes image processing on the respective areas with different settings. The image processing unit 324 can thereby execute image processing appropriate for the contents of the image data. The image area separation processing is executed by a known image area separation technique.

The CPU 321 is also connected to the control unit 1032 of the printer 1001A via the system bus 332. The above-described environment sensor unit 313 is connected to the control unit 1032. Specifically, the temperature sensor 313a for detecting a temperature and the humidity sensor 313b for detecting a humidity are connected to the control unit 1032. The control unit 1032 controls the image forming condition of the image forming unit 1033 based on a signal output from the environment sensor unit 313. The CPU 301 of the reader controller 300 can also receive the environment information acquired by the environment sensor unit 313 via the command data bus 330. With this configuration, the CPU 301 can control the image reading apparatus 1005 based on the environment information acquired by the environment sensor unit 313.

### Feeding-Reading Control

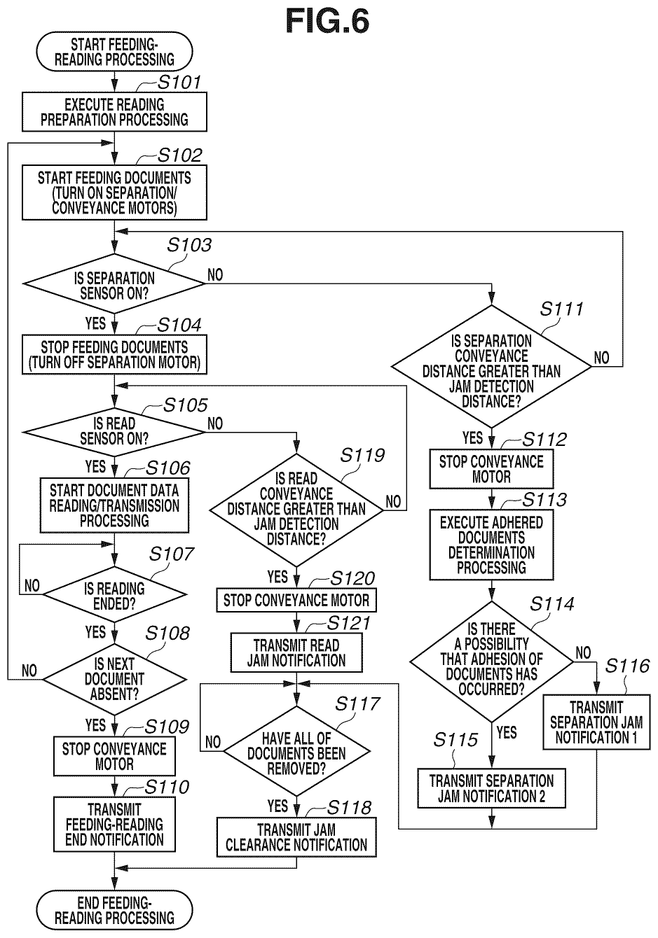

Next, feeding-reading control according to the present exemplary embodiment will be described. FIG. 6 is a flowchart illustrating the operation of the reader controller 300 when feeding-reading processing is executed. The flowchart in FIG. 6 is executed by the CPU 301 when the user inputs a feeding-reading start instruction (i.e., reading/copying start instruction) via the operation unit 90.

When the CPU 301 receives the feeding-reading start instruction, the CPU 301 executes, in step $101, reading preparation processing such as reading resolution setting, color mode setting, and shading processing. Herein, the CPU 321 notifies the CPU 301 of detection values (values of a temperature and a humidity) of the environment sensor unit 313 acquired via the control unit 1032 together with the feeding-reading start instruction. In step S102, when the reading preparation processing is completed, the CPU 301 starts driving the separation motor 310 and the conveyance motor 311 to start feeding documents. At this time, the separation motor 310 is driven to make the pick-up roller 205 fall onto the upper face of a document, so that feeding of the document is started.

In step S103, the CPU 301 starts checking the separation sensor 209. In a case where the separation sensor 209 is off (NO in step S103), i.e., in a case where the document has not reached the separation sensor 209, the processing proceeds to step S111. In step S111, the CPU 301 compares a separation conveyance distance after starting the document-feeding and a jam detection distance set previously. In step S111, the CPU 301 checks whether a separation jam has occurred. In a case where the separation conveyance distance after starting the document-feeding is longer than the jam detection distance (YES in step S111), the CPU 301 determines that a separation jam has occurred. In a case where the separation conveyance distance after starting the document-feeding is less than the jam detection distance (NO in step S111), the CPU 301 checks again whether the separation sensor 209 is turned on. In other words, the CPU 301 repeatedly checks the separation sensor 209 until the separation sensor 209 is turned on in step S103, or the separation conveyance distance after starting the document-feeding exceeds the jam detection distance in step S111.

In a case where the separation sensor 209 is turned on in step S103 (YES in step S103) before the separation conveyance distance after starting the document-feeding exceeds the jam detection distance in step S111, the processing proceeds to step S104. In step S104, the CPU 301 stops feeding the documents by stopping the separation motor 310. At this time, although feeding of the next document is stopped, feeding of the separated document is continuously executed by the conveyance motor 311.

Thereafter, in step S105, the CPU 301 starts checking the read sensor 212. In a case where the read sensor 212 is off (NO in step S105), i.e., in a case where the document has not reached the read sensor 212, the processing proceeds to step S119. In step S119, the CPU 301 compares a read conveyance distance after turning on the separation sensor 209 and a jam detection distance set previously. In step S119, the CPU 301 checks whether a read jam has occurred. Herein, in a case where the read conveyance distance after turning on the separation sensor 209 is longer than the jam detection distance (YES in step S119), the CPU 301 determines that a read jam has occurred. In a case where the read conveyance distance after turning on the separation sensor 209 is less than the jam detection distance (NO in step S119), the CPU 301 checks again whether the read sensor 212 is turned on. In other words, the CPU 301 repeatedly checks the read sensor 212 until the read sensor 212 is turned on in step S105, or the read conveyance distance after turning on the separation sensor 209 exceeds the jam detection distance in step S119. Here, the jam detection distance in step S119 is different from the jam detection distance in step S111.

In a case where the read sensor 212 is turned on in step S105 before the read conveyance distance after turning on the separation sensor 209 exceeds the jam detection distance in step S119 (YES in step S105), the processing proceeds to step S106. In step S106, the CPU 301 starts executing document reading processing and transmission processing. In step S106, the CPU 301 reads images on both faces of the document through the front face reading unit 103 and the back face reading unit 216. The CPU 301 then transmits the read image data from the image processing unit 305 to the image processing unit 324.

In step S107, the CPU 301 checks a reading state with the image processing unit 305, and waits for a reading end notification. When the CPU 301 determines that reading is ended (YES in step S107), the processing proceeds to step S108. In step S108, the CPU 301 checks the document detection sensor 204. In a case where the next document is present (NO in step S108), the processing returns to step S102. In step S102, the CPU 301 drives the separation motor 310 again to start feeding the next document. In a case where the next document is absent (YES in step S108), the processing proceeds to step S109. In step S109, the CPU 301 executes discharge processing to stop the conveyance motor 311 after driving the conveyance motor 311 by a predetermined distance. In step S110, the CPU 301 transmits a feeding-reading end notification to the CPU 321, and ends the feeding-reading control.

The above-described processing in steps S102 to S110 is executed when a jam does not occur. Next, processing to be executed when a jam occurs will be described. In step S111, in a case where the separation conveyance distance after starting the document-feeding exceeds the jam detection distance, the CPU 301 determines that a separation jam has occurred, so that the processing proceeds to step S112. In step S112, the CPU 301 stops the separation motor 310 and the conveyance motor 311 to stop conveying the document. In other words, in a case where the separation sensor 209 does not detect a document within a predetermined time after starting the document-feeding, the CPU 301 determines that a separation jam has occurred, and stops feeding the document. In step S113, the CPU 301 executes adhered documents determination processing. The adhered documents determination processing will be described below in detail. In step S113, the CPU 301 determines whether there is a possibility that adhesion of documents has occurred based on the environment information acquired by the environment sensor unit 313.

In step S114, in a case where the environment information acquired by the environment sensor unit 313 satisfies a condition where adhesion of documents is likely to occur (YES in step S114), the processing proceeds to step S115. In step S115, the CPU 301 transmits a separation jam notification 2 to the CPU 321. In a case where the environment information does not satisfy the condition (NO in step S114), the processing proceeds to step S116. In step S116, the CPU 301 transmits a separation jam notification 1 to the CPU 321. Although both of the separation jam notifications 1 and 2 are information indicating occurrence of a jam at the separation mechanisms of the ADF 200, the separation jam notifications 1 and 2 are different notifications. Specifically, the separation jam notification 2 is a notification transmitted when there is a high possibility that a jam has occurred because of adhesion of documents, and the separation jam notification 1 is a notification transmitted when there is a high possibility that a jam has occurred because of a reason other than the adhesion of documents. For example, so-called rough-set, i.e., a state where documents are not correctly set to the document tray 201, can be considered as a cause of a jam other than the adhesion of documents.

In step S117, after the separation jam notification is transmitted in step S115 or S116, the CPU 301 checks states of the separation sensor 209 and the read sensor 212, checks whether no document remains in the conveyance path, and waits until all of the sensors are turned off. In a case where all of the documents are removed by the user and both of the separation sensor 209 and the read sensor 212 are turned off (YES in step S117), the processing proceeds to step S118. In step S118, the CPU 301 notifies the CPU 321 of clearance of a jam, and ends the feeding-reading control.

In a case where the read conveyance distance after turning on the separation sensor 209 exceeds the jam detection distance, the CPU 301 determines that a read jam has occurred (YES in step S119), the processing proceeds to step S120. In step S120, the CPU 301 stops the conveyance motor 311 to stop conveying the document. In step S121, the CPU 301 transmits a read jam notification to the CPU 321. The read jam notification is information indicating occurrence of a jam at a position downstream of the separation unit. After the read jam notification is transmitted, the processing proceeds to step S117 described above. When the jam is cleared, the feeding-reading control is ended.

### Adhered Documents Determination Processing

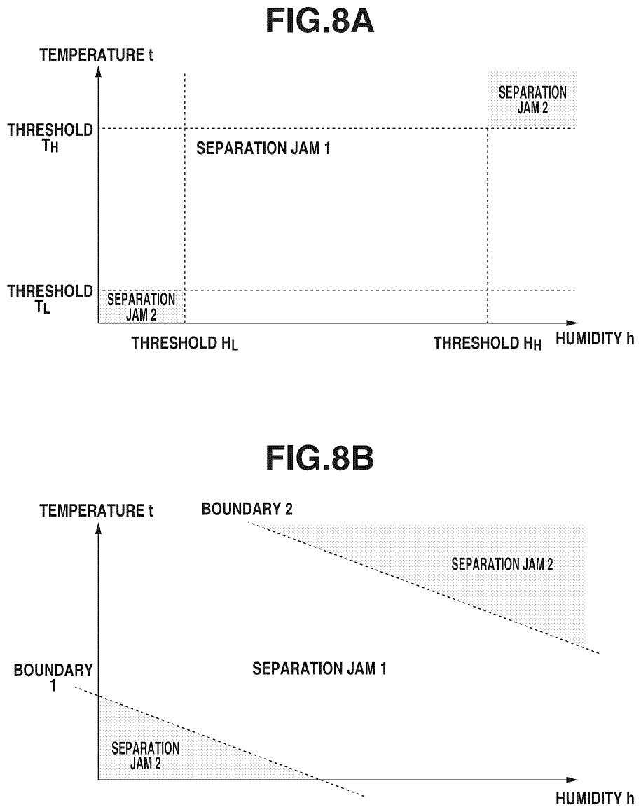

Next, adhered documents determination processing executed in step S113 will be described with reference to FIGS. 8A and 8B. FIG. 8A is a diagram illustrating an example of conditions for making a determination of an environment where adhesion of documents is likely to occur. In FIG. 8A, gray regions illustrate conditions where adhesion of documents is likely to occur. Specifically, a region where a temperature and a humidity are respectively lower than or equal to a first temperature T_{L} and a first humidity H_{L}, and a region where a temperature and a humidity are respectively higher than or equal to a second temperature TH and a second humidity HH are illustrated as the conditions where adhesion of documents is likely to occur.

When the CPU 301 executes the adhered documents determination processing, the CPU 301 acquires environment information from the environment sensor unit 313. As illustrated in FIG. 8A, in a case where both of the temperature and the humidity are less than or equal to the first thresholds (e.g., the first temperature T_{L} and the first humidity H_{L}), or greater than or equal to the second thresholds (e.g., the second temperature T_{H} and the second humidity H_{H}), the CPU 301 determines that adhesion of documents is likely to occur. The CPU 301 determines that adhesion of documents hardly occurs in other cases. In other words, in a case where both of the temperature and the humidity are either less than or equal to the first thresholds, or greater than or equal to the second thresholds in step S115, the CPU 301 transmits the separation jam notification 2 to the CPU 321. In other cases, the CPU 301 transmits, in step S116, the separation jam notification 1.

Further, determination of a condition where adhesion of documents easily occurs is not limited to the above. FIG. 8B is a diagram illustrating another example of a condition for making a determination of an environment where adhesion of documents is likely to occur. In FIG. 8B, gray regions also illustrate the conditions where adhesion of documents is likely to occur. Specifically, a region where a temperature and a humidity are respectively lower than or equal to a boundary 1 and a region where a temperature and a humidity are respectively higher than or equal to a boundary 2 are illustrated as the conditions where adhesion of documents is likely to occur.

Herein, an equation of a straight line of the boundary 1 is expressed as follows.

$$t = - {A}_{L} \times h + {B}_{L} ,$$

where “t” represents a temperature, “h” represents a humidity, and “A_{L}” and “B_{L}” are predetermined constants. In this case, if a temperature and a humidity are “T_{X}” and “H_{X}”, respectively, the CPU 301 determines that adhesion of documents is likely to occur when “T_{X}” and “H_{X}” satisfy the following condition.

$${T}_{X} + {A}_{L} \times {H}_{X} \leq {B}_{L}$$

Further, an equation of a straight line of the boundary 2 is expressed as follows.

$$t = - {A}_{H} \times h + {B}_{H}$$

Herein, “A_{H}” and “B_{H}” are also predetermined constants. In this case, if a temperature and a humidity are “T_{X}” and “H_{X}”, respectively, the CPU 301 determines that adhesion of documents is likely to occur when “T_{X}” and “H_{X}” satisfy the following condition.

$${T}_{X} + {A}_{H} \times {H}_{X} \geq {B}_{H}$$

As described above, when the environment information acquired by the environment sensor unit 313 satisfies a predetermined condition, the CPU 301 determines that adhesion of documents is likely to occur in that condition. In the above example, the CPU 301 determines whether adhesion of documents is likely to occur in the condition based on both of the temperature and the humidity. However, the present exemplary embodiment is not limited thereto. The CPU 301 can determine whether adhesion of documents is likely to occur in the condition based on any one of the temperature and the humidity. For example, a predetermined condition for the CPU 301 to determine that there is a possibility that adhesion of documents has occurred can be only one condition where a temperature is lower than or equal to the first temperature T_{L}. Similarly, the predetermined condition can be any one of the following conditions where a humidity is lower than or equal to the first humidity H_{L}, where a temperature is higher than or equal to the second temperature T_{H}, and where a humidity is higher than or equal to the second humidity H_{H}. The predetermine condition can also be a condition that satisfies optional two conditions from among the above-described conditions. For example, the predetermined condition can be a condition where a temperature is lower than or equal to the first temperature T_{L} and a humidity is lower than or equal to the first humidity H_{L}. As described above, it is desirable that the predetermined condition be optionally set based on the characteristics of the apparatus.

### UI Control When jam Occurs

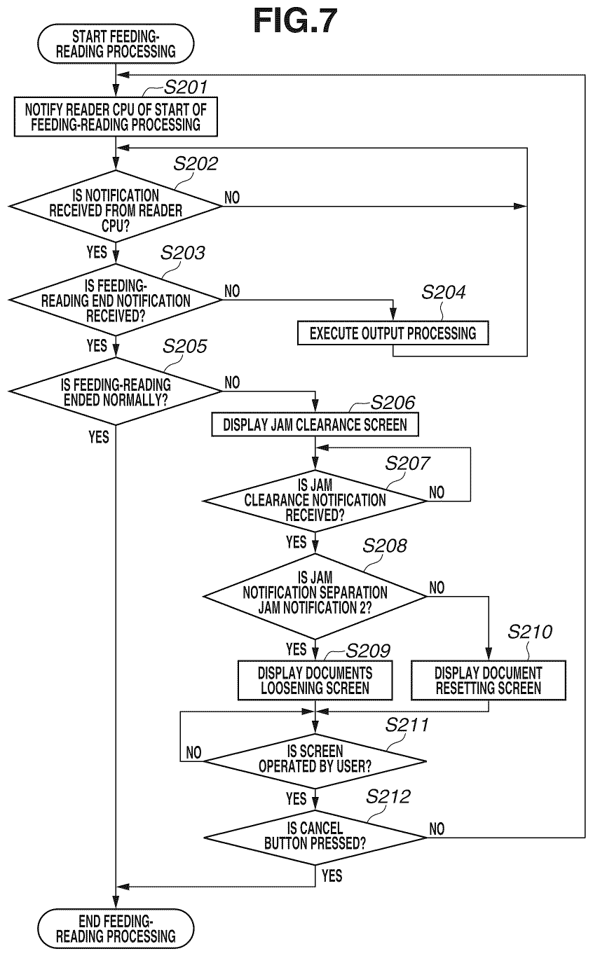

System control according to the present exemplary embodiment will now be described with reference to FIG. 7. FIG. 7 is a flowchart illustrating the operation of the system controller 320 in the feeding-reading control according to the present exemplary embodiment, executed by the CPU 321.

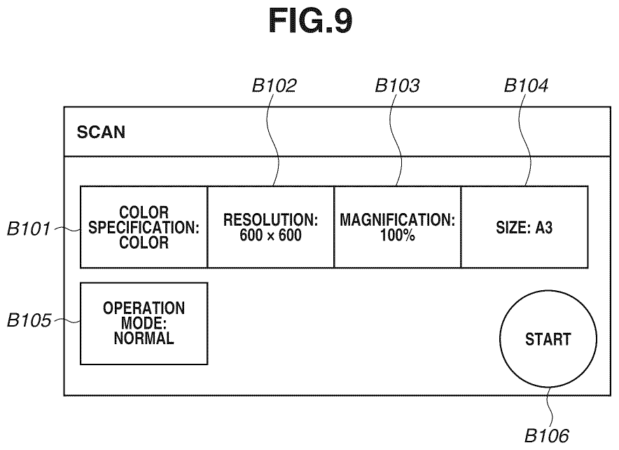

FIGS. 9 to 12 are diagrams illustrating screens to be displayed on the display 91 of the operation unit 90.

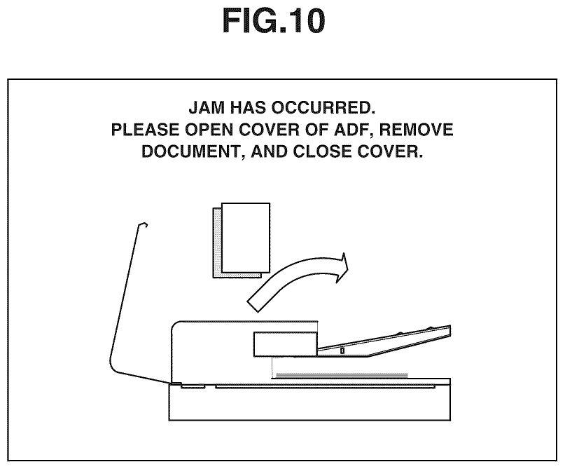

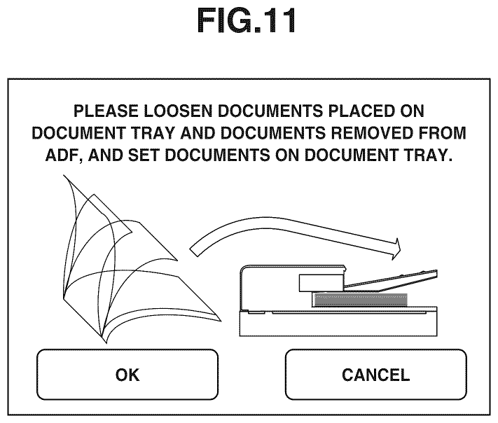

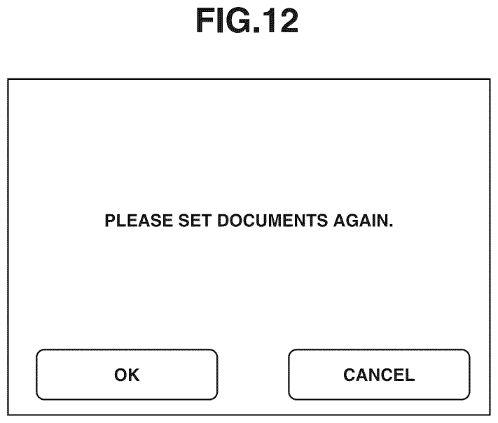

FIG. 9 illustrates a job input screen displayed before a job is started. FIG. 10 illustrates a jam clearance screen for prompting the user to remove a document when a jam occurs. On the screen, a message for prompting the user to remove a document is displayed. FIG. 11 illustrates a document loosening screen displayed when the separation jam notification 2 is transmitted, and a message prompting the user to set documents on the document tray 201 after loosening the documents is displayed on the screen. The document loosening screen in FIG. 11 is an example of a predetermined screen for prompting the user to loosen documents. FIG. 12 illustrates a document resetting screen displayed when the separation jam notification 1 is transmitted, and a message for prompting the user to set documents on the document tray 201 is displayed on the screen. These two screens illustrated in FIGS. 11 and 12 are different in that a message for prompting the user to loosen documents is displayed on the document loosening screen of FIG. 11, but not displayed on the document resetting screen of FIG. 12. In the present exemplary embodiment, “loosening the documents” means “unsticking the documents by undoing the bundle of documents”. For example, the documents can be loosened by flipping the bundle of documents and putting air between the documents.

The job input screen in FIG. 9 is displayed on the operation unit 90 before feeding-reading processing is started. On the job input screen, soft keys are displayed, such as a reading color specification button B101, a resolution specification button B102, a magnification specification button B103, a document size specification button B104, an operation mode specification button B105, and a start button B106. The user can input optional settings related to document image reading processing to the job input screen. When the user presses the start button B106 after inputting the settings, the CPU 321 starts executing feeding-reading control.

In step S201, the CPU 321 recognizes that a feeding-reading instruction is input through the operation unit 90, and notifies the CPU 301 of start of the feeding-reading processing. At this time, the CPU 321 notifies the CPU 301 of an operation mode selected by the user in addition to the settings necessary to execute reading processing, such as a reading color specification, a resolution, and a document size, set by the user through the operation unit 90.

Thereafter, in step S202, the CPU 321 waits for a notification from the CPU 301. The notification from the CPU 301 is the information transmitted to the CPU 321 from the CPU 301, such as the image data of a document read in step S106 or the feeding-reading end notification transmitted in step S110 in FIG. 6. When the CPU 321 receives a notification from the CPU 301 (YES in step S202), the processing proceeds to step S203. In step S203, the CPU 321 checks contents of the notification. In a case where the contents of the notification is image data of a document (NO in step S203), the processing proceeds to step S204. In step S204, based on the instruction input by the user when the job is started, the CPU 321 executes image output processing to print a read image and store the read image as an image file in a ROM. Thereafter, the processing returns to step S202, and the CPU 321 checks whether a notification is received from the CPU 301. In a case where the contents of the notification is the feeding-reading end notification (YES in step S203), the processing proceeds to step S205. In step S205, the CPU 321 checks a result described in the feeding-reading end notification. In a case where the reading result is “Normal” (YES in step S205), the CPU 321 ends the feeding-reading control. The reading result becomes “Normal” when the feeding-reading control is ended after a document image is read without occurrence of a jam.

In a case where the reading result described in the feeding-reading end notification is “Jam” (NO in step S205), the processing proceeds to step S206. In step S206, the CPU 321 displays a jam clearance screen illustrated in FIG. 10 on the operation unit 90, and prompts the user to remove a document remaining in the ADF 200. Thereafter, in step S207, the CPU 321 checks a notification from the CPU 301 again, and waits for a jam clearance notification. When the CPU 301 receives a jam clearance notification, in step S208, the CPU 321 checks contents of the jam notification transmitted at the end of the feeding-reading processing. Herein, the jam notification checked by the CPU 321 is any one of the separation jam notification 2 transmitted in step S115, the separation jam notification 1 transmitted in step S116, and the read jam notification transmitted in step S121 in FIG. 6.

In a case where the contents of the jam notification are the separation jam notification 2 (YES in step S208, there is a possibility that the separation jam has occurred because of adhesion of documents. Therefore, the processing proceeds to step S209. In step S209, the CPU 321 displays the document loosening screen in FIG. 11, and prompts the user to resolve the adhesion of documents. On the other hand, in a case where the contents of the jam notification are the separation jam notification 1 or the read jam notification (NO in step S208), there is a high possibility that the separation jam has occurred because of a reason other than the adhesion of documents. Therefore, the processing proceeds to step S210. In step S210, the CPU 321 displays the document resetting screen in FIG. 12, and prompts the user to reset the documents.

Thereafter, in step S211, the CPU 321 checks the user's operation performed on the screen, and waits until the user operates the operation unit 90 after resetting the documents. When the CPU 321 detects that the user has operated the operation unit 90 (YES in step S211), the processing proceeds to step S212. In step S212, the CPU 321 checks the contents input by the user. In a case where the user has pressed a Cancel button displayed on the screen in FIG. 11 or 12 (YES in step S212), the CPU 321 ends the feeding-reading processing. In a case where the user has pressed an OK button (NO in step S212), the processing returns to step S201. In step S201, the CPU 321 notifies the CPU 301 of start of the feeding-reading processing again, and executes feeding-reading control continuously.

As described above, in the present exemplary embodiment, when a separation jam is detected, the image reading apparatus 1005 changes a jam clearance screen to be notified to the user based on the environment information acquired from the environment sensor unit 313. Specifically, in a case where the environment information acquired by the environment sensor unit 313 satisfies a predetermined condition, the image reading apparatus 1005 displays a screen for prompting the user to loosen the documents. In contrast, in a case where the environment information acquired by the environment sensor unit 313 does not satisfy the predetermined condition, the image reading apparatus 1005 does not display the screen for prompting the user to loosen the documents. In a case where the environment where the image reading apparatus 1005 is installed satisfies a condition where adhesion of documents is likely to occur, the image reading apparatus 1005 can thereby prevent occurrence of repetitive jams by prompting the user to loosen the documents. In a case where the environment where the image reading apparatus 1005 is installed satisfies a condition where adhesion of documents hardly occurs, the image reading apparatus 1005 does not prompt the user to loosen the documents. Thus, the user does not have to execute unnecessary operation, so that operability of the apparatus is improved.

According to the present exemplary embodiment, the CPU 301 also determines whether adhesion of documents is likely to occur in the environment based on both of the temperature and the humidity acquired by the environment sensor unit 313.

It is thereby possible to improve the accuracy of determining whether adhesion of documents is likely to occur in the environment. However, the CPU 301 can determine whether adhesion of documents is likely to occur in the environment based on any one of the temperature and the humidity acquired by the environment sensor unit 313. In this case, only one of the temperature sensor 313a and the humidity sensor 313b has to be mounted on the apparatus, and it is therefore possible to reduce the cost of the apparatus.

According to the present exemplary embodiment, the CPU 321 displays the document loosening screen in FIG. 11 or the document resetting screen in FIG. 12 after displaying the jam clearance screen in FIG. 10. In this way, the user can appropriately judge how the user should handle the documents removed from the apparatus after occurrence of a jam, and thereby operability of the apparatus can be improved. In other words, it is preferable that the document loosening screen in FIG. 11 and the document resetting screen in FIG. 12 be displayed after the jam clearance screen in FIG. 10 but not before the jam clearance screen.

According to the present exemplary embodiment, the CPU 301 determines whether the environment where the image reading apparatus 1005 is installed satisfies a condition where adhesion of documents is likely to occur based on the environment sensor unit 313 arranged on the printer 1001A. The printer 1001A also controls a fixing temperature of the fixing device 1029 based on the environment information acquired by the environment sensor unit 313. As described above, the environment information acquired by the environment sensor unit 313 is used for both of the control executed by the printer 1001A and the control executed by the image reading apparatus 1005. The number of sensors can thereby be reduced, so that the cost of the apparatus can be reduced. The environment sensor unit 313 can also be arranged on the image reading apparatus 1005. In this case, the CPU 321 can determine whether adhesion of documents is likely to occur in the condition more accurately.

Further, the ADF 200 includes the double-feeding sensor 221 downstream of the separation roller pair 206. In a case where the double-feeding sensor 221 detects the documents fed in a double feeding state, the CPU 321 stops conveying the documents by stopping the separation motor 310 and the conveyance motor 311. In a case where the double-feeding sensor 221 detects the documents fed in a double feeding state, the CPU 301 transmits the separation jam notification 2 to the CPU 321 regardless of the environment information acquired by the environment sensor unit 313. In other words, in a case where the double-feeding sensor 221 detects the documents fed in a double feeding state, the image reading apparatus 1005 displays a screen for prompting the user to loosen the documents regardless of the environment information acquired by the environment sensor unit 313. This is because adhesion of documents can occur depending on a document type, even it is not in the environment satisfying a condition where adhesion of documents is likely to occur. For example, adhesion of documents is likely to occur when coated paper is used for the documents. In a case where the double-feeding sensor 221 detects the documents fed in a double feeding state, the image reading apparatus 1005 can therefore prevent occurrence of repetitive jams by displaying a screen for prompting the user to loosen the documents.

Next, a second exemplary embodiment according to the present disclosure will be described. In the first exemplary embodiment, when a separation jam is detected, a jam clearance screen to be notified to the user is changed based on the environment information acquired from the environment sensor unit 313. In contrast, the present exemplary embodiment is different from the first exemplary embodiment in that the jam clearance screen to be notified to the user is changed based on the number of times of continuous separation jams when a separation jam is detected. In addition, a basic structure of the image forming apparatus 1001 and a configuration of the controller according to the present exemplary embodiment are similar to those described in the first exemplary embodiment. Thus, descriptions thereof will be omitted.

### Feeding-Reading Control

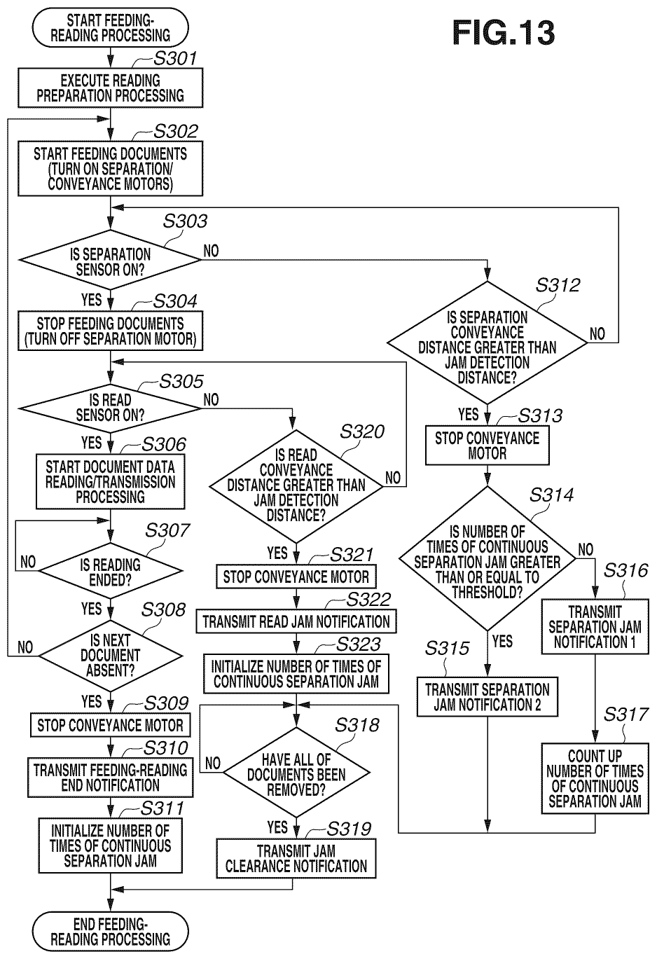

Next, feeding-reading control according to the present exemplary embodiment will be described. FIG. 13 is a flowchart illustrating the operation flow of the reader controller 300 when feeding-reading processing is executed. The flowchart illustrated in FIG. 13 is executed by the CPU 301 when the user issues a feeding-reading start instruction (e.g., reading/copying start instruction) via the operation unit 90.

When the CPU 301 receives the feeding-reading start instruction, the CPU 301 executes, in step S301, reading preparation processing such as reading resolution setting, color mode setting, and shading processing. When the reading preparation processing is completed, the CPU 301 starts, in step S302, driving the separation motor 310 and the conveyance motor 311 to start feeding documents. The separation motor 310 is driven to make the pick-up roller 205 fall onto the upper face of the documents, so that feeding of the documents is started.

In step S303, the CPU 301 starts checking the separation sensor 209. In a case where the separation sensor 209 is off (NO in step S303), in other words, in a case where the document has not reached the separation sensor 209, the processing proceeds to step S312. In step S312, the CPU 301 compares a separation conveyance distance after starting the document-feeding and a jam detection distance set previously. In step S312, the CPU 301 checks whether a separation jam has occurred. Herein, in a case where the separation conveyance distance after starting the document-feeding is longer than the jam detection distance (YES in step S312), the CPU 301 determines that a separation jam has occurred. In a case where the separation conveyance distance after starting the document-feeding is less than the jam detection distance (NO in step S312), the processing proceeds to step S303 for the CPU 301 to newly check whether the separation sensor 209 is turned on. In other words, the CPU 301 repeatedly checks the separation sensor 209 until the separation sensor 209 is turned on in step S303, or the separation conveyance distance after starting the document-feeding exceeds the jam detection distance in step S312.

In a case where the separation sensor 209 is turned on in step S303 (YES in step S303) before the separation conveyance distance after starting the document-feeding exceeds the jam detection distance in step S312, the processing proceeds to step S304. In step S304, the CPU 301 stops feeding the documents by stopping the separation motor 310. At this time, feeding of the next document is stopped, but feeding of the separated document is continuously executed by the conveyance motor 311.

Thereafter, in step S305, the CPU 301 starts checking the read sensor 212. In a case where the read sensor 212 is off (NO in step S305), in other words, in a case where the document has not reached the read sensor 212, the processing proceeds to step S320. In step S320, the CPU 301 compares a read conveyance distance after turning on the separation sensor 209 and a jam detection distance set previously. In step S320, the CPU 301 checks whether a read jam has occurred. Herein, in a case where the read conveyance distance after turning on the separation sensor 209 is longer than the jam detection distance (YES in step S320), the CPU 301 determines that a read jam has occurred. In a case where the read conveyance distance after turning on the separation sensor 209 is less than the jam detection distance (NO in step S320), the processing proceeds to step S305 for the CPU 301 to newly check whether the read sensor 212 is turned on. In other words, the CPU 301 repeatedly checks the read sensor 212 until the read sensor 212 is turned on in step S305, or the read conveyance distance after turning on the separation sensor 209 exceeds the jam detection distance in step S320. The jam detection distance used in step S320 is different from the jam detection distance used in step S312.

In a case where the read sensor 212 is turned on in step S305 (YES in step S305) before the read conveyance distance after turning on the separation sensor 209 exceeds the jam detection distance in step S320, the processing proceeds to step S306. In step S306, the CPU 301 starts executing document reading processing and transmission processing. In step S306, the CPU 301 reads images of both faces of the document through the front face reading unit 103 and the back face reading unit 216. The CPU 301 then transmits the read image data from the image processing unit 305 to the image processing unit 324.

Thereafter, in step S307, the CPU 301 checks a reading state with the image processing unit 305, and waits for a reading end notification. When the CPU 301 determines that reading is ended (YES in step S307), the processing proceeds to step S308. In step S308, the CPU 301 checks the document detection sensor 204. In a case where the next document is present (NO in step S308), the processing returns to step S302. In step S302, the CPU 301 drives the separation motor 310 again to start feeding the next document. In a case where the next document is absent (YES in step S308), the processing proceeds to step $309. In step S309, the CPU 301 executes discharge processing to stop the conveyance motor 311 after driving the conveyance motor 311 by a predetermined distance. Thereafter, in step S310, the CPU 301 notifies the CPU 321 of the end of reading. In step S311, the CPU 301 initializes the number of times of continuous separation jams described below. Thereafter, the CPU 301 ends the feeding-reading processing.

The above-described processing in steps S302 to S311 is executed in a case where a jam has not occurred. Next, processing to be executed when a jam has occurred will be described. In step S312, in a case where the separation conveyance distance after starting the document-feeding exceeds the jam detection distance, the CPU 301 determines that a separation jam has occurred (YES in step S312), so that the processing proceeds to step S313. In step S313, the CPU 301 stops conveying the documents by stopping the separation motor 310 and the conveyance motor 311. In other words, in a case where the separation sensor 209 does not detect a document within a predetermined time after starting the document-feeding, the CPU 301 determines that a separation jam has occurred, and stops feeding the documents.

In step S314, the CPU 301 checks the number of times of continuous separation jams. The number of times of continuous separation jams refers to how many times jams have continuously occurred at the separation unit of the ADF 200. The number of times of continuous separation jams is stored in the RAM 303. The number of times of continuous separation jams is set to zero when the CPU 301 is activated. Initialization of the number of times of continuous separation jams refers to the processing for overwriting the number of times of continuous separation jams stored in the RAM 303 with zero. In step S314, in a case where the number of times of continuous separation jams is a predetermined threshold or more (YES in step S314), the processing proceeds to step S315. In step S315, the CPU 301 transmits the separation jam notification 2 to the CPU 321. In contrast, in step S314, in a case where the number of times of continuous separation jams is less than the predetermined threshold (NO in step S314), the processing proceeds to step S316. In step S316, the CPU 301 transmits the separation jam notification 1 to the CPU 321. After the separation jam notification 1 is transmitted, the CPU 301 counts up, in step S317, the number of times of continuous separation jams.

Herein, similarly to the first exemplary embodiment, both of the separation jam notifications 1 and 2 are information indicating occurrence of a jam at the separation unit, but the separation jam notifications 1 and 2 are different notifications. The separation jam notification 2 is a notification transmitted when there is a high possibility that a jam has occurred because of adhesion of documents, and the separation jam notification 1 is a notification transmitted when there is a high possibility that a jam has occurred because of a reason other than the adhesion of documents.

In the present exemplary embodiment, a threshold for the number of times of continuous separation jams for notifying the separation jam notification 2 is two. In other words, in a case where the separation jams occur two times continuously, the CPU 301 transmits the separation jam notification 2 to the CPU 321. However, the threshold for the number of times of continuous separation jams can optionally be set to a value 2 or greater.

After the separation jam notification is transmitted in step S315 or S316, the CPU 301 checks, in step S318, the states of the separation sensor 209 and the read sensor 212, checks whether no document remains in the conveyance path, and waits until all of the sensors are turned off. In a case where all of documents are removed by the user, so that both of the separation sensor 209 and the read sensor 212 are turned off (YES in step S318), the processing proceeds to step S319. In step S319, the CPU 301 notifies the CPU 321 of clearance of a jam, and ends the feeding-reading control.

In step S320, in a case where the read conveyance distance after turning on the separation sensor 209 exceeds the jam detection distance, the CPU 301 determines that a read jam has occurred, and the processing proceeds to step S321. In step S321, the CPU 301 stops the conveyance motor 311 to stop conveying the documents. In step S322, the CPU 301 transmits a read jam notification to the CPU 321. The read jam notification is information indicating occurrence of a jam at a position downstream of the separation unit. After the read jam notification is transmitted, the CPU 301 initializes, in step S323, the number of times of continuous separation jams. Thereafter, the processing proceeds to step S318 described above. Then, the feeding-reading control is ended when the jam is cleared.

### UI Control When jam Occurs

The operation performed by the system controller 320 when a jam occurs is similar to the operation described in FIG. 7. In other words, in a case where the CPU 321 of the system controller 320 receives the separation jam notification 2 from the CPU 301 (YES in step S208), there is a possibility that a separation jam occurs because of adhesion of documents, and the processing proceeds to step S209. In step S209, the CPU 321 displays the document loosening screen illustrated in FIG. 11. In contrast, in a case where the CPU 321 receives the separation jam notification 1 or the read jam notification from the CPU 301 (NO in step S208), there is a possibility that a separation jam occurs because of a reason other than adhesion of documents, and the processing proceeds to step S210. In step S210, the CPU 321 displays the document resetting screen illustrated in FIG. 12.

As described above, according to the present exemplary embodiment, the image reading apparatus 1005 changes the jam clearance screen to be notified to the user based on the number of times of continuous occurrence of jam at the separation unit.

Specifically, the image reading apparatus 1005 displays a screen prompting the user to loosen the documents in a case where separation jams have continuously occurred for the number of times greater than or equal to a predetermined threshold. In contrast, in a case where the number of times of continuous separation jams is less than the threshold, the image reading apparatus 1005 does not display a screen for prompting the user to loosen the documents. This makes it possible to prevent occurrence of repetitive jams exceeding the threshold.

In a case where the double-feeding sensor 221 detects the documents fed in a double feeding state, the CPU 301 transmits the separation jam notification 2 to the CPU 321 regardless of the number of times of continuous separation jams. In other words, in a case where the double-feeding sensor 221 detects the documents fed in a double feeding state, the image reading apparatus 1005 displays a screen for prompting the user to loosen the documents regardless of the number of times of continuous separation jams. This makes it possible to prevent occurrence of repetitive jams even in a case of a document type that is likely to be adhered to each other.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-111309, filed Jul. 10, 2024, which is hereby incorporated by reference herein in its entirety.

What is claimed is:

1. A document conveyance apparatus comprising:
a document tray on which documents are stacked;
a separation feeding unit configured to form a separation nip for separating the documents stacked on the document tray one by one and to feed a document separated by the separation nip in a feeding direction;
a detection sensor configured to detect the document at a position downstream of the separation nip in the feeding direction;
a controller configured to stop feeding of the document executed by the separation feeding unit, in a case where the detection sensor does not detect the document within a predetermined time after the separation feeding unit starts feeding of the document;
an environment sensor configured to acquire environment information including at least any one of a temperature and a humidity; and
a display,
wherein, when the controller stops feeding of the document based on the detection sensor, (a) in a case where the environment information acquired by the environment sensor satisfies a predetermined condition, the display displays a screen for prompting a user to loosen a bundle of documents, and (b) in a case where the environment information acquired by the environment sensor does not satisfy the predetermined condition, the display does not display the screen for prompting the user to loosen the bundle of documents.

2. The document conveyance apparatus according to claim 1, wherein the predetermined condition is a case where a temperature detected by the environment sensor is lower than a first temperature.

3. The document conveyance apparatus according to claim 1, wherein the predetermined condition is a case where a temperature detected by the environment sensor is higher than a second temperature.

4. The document conveyance apparatus according to claim 1, wherein the predetermined condition is a case where a temperature detected by the environment sensor is lower than a first temperature, and that a temperature detected by the environment sensor is higher than a second temperature that is higher than the first temperature.

5. The document conveyance apparatus according to claim 1, wherein the predetermined condition is a case where a humidity detected by the environment sensor is lower than a first humidity.

6. The document conveyance apparatus according to claim 1, wherein the predetermined condition is a case where a humidity detected by the environment sensor is higher than a second humidity.

7. The document conveyance apparatus according to claim 1, wherein the predetermined condition is a case where the humidity detected by the environment sensor is lower than a first humidity, and that the humidity detected by the environment sensor is higher than a second humidity that is higher than the first humidity.

8. The document conveyance apparatus according to claim 1, wherein the predetermined condition is a case where a temperature detected by the environment sensor is lower than a first temperature and a humidity detected by the environment sensor is lower than a first humidity.

9. The document conveyance apparatus according to claim 1, wherein the predetermined condition is a case where a temperature detected by the environment sensor is higher than a second temperature and a humidity detected by the environment sensor is higher than a second humidity.

10. The document conveyance apparatus according to claim 1, wherein the predetermined condition is a case where a temperature detected by the environment sensor is lower than a first temperature and a humidity detected by the environment sensor is lower than a first humidity, and a case where a temperature detected by the environment sensor is higher than a second temperature that is higher than the first temperature and a humidity detected by the environment sensor is higher than a second humidity that is higher than the first humidity.

11. The document conveyance apparatus according to claim 1, wherein the display displays the screen for prompting the user to loosen the bundle of documents after displaying a screen for prompting the user to remove the documents from an inner portion of the document conveyance apparatus.

12. The document conveyance apparatus according to claim 1, further comprising a double-feeding sensor arranged at a position downstream of the detection sensor in the feeding direction, configured to detect presence of documents fed by the separation feeding unit in a double feeding state,
wherein, in a case where the double-feeding sensor detects presence of documents in a double feeding state, the display displays the screen for prompting the user to loosen the bundle of documents regardless of the environment information acquired by the environment sensor.

13. An image reading apparatus comprising:
a document tray on which documents are stacked;
a separation feeding unit configured to form a separation nip for separating the documents stacked on the document tray one by one and to feed a document separated by the separation nip in a feeding direction;
a detection sensor configured to detect the document at a position downstream of the separation nip in the feeding direction;
a controller configured to stop feeding of the document executed by the separation feeding unit, in a case where the detection sensor does not detect the document within a predetermined time after the separation feeding unit starts feeding of the document;
an environment sensor configured to acquire environment information including at least any one of a temperature and a humidity;
a display; and
a reading unit configured to read an image of the document fed by the separation feeding unit,
wherein, when the controller stops feeding of the document based on the detection sensor, (a) in a case where the environment information acquired by the environment sensor satisfies a predetermined condition, the display displays a screen for prompting a user to loosen a bundle of documents, and (b) in a case where the environment information acquired by the environment sensor does not satisfy the predetermined condition, the display does not display the screen for prompting the user to loosen the bundle of documents.

14. An image forming apparatus comprising:
a document tray on which documents are stacked;
a separation feeding unit configured to form a separation nip for separating the documents stacked on the document tray one by one and to feed a document separated by the separation nip in a feeding direction;
a detection sensor configured to detect the document at a position downstream of the separation nip in the feeding direction;
a controller configured to stop feeding of the document executed by the separation feeding unit, in a case where the detection sensor does not detect the document within a predetermined time after the separation feeding unit starts feeding of the document;
an environment sensor configured to acquire environment information including at least any one of a temperature and a humidity;
a display;
a reading unit configured to read an image of the document fed by the separation feeding unit, and
an apparatus main body including an image forming unit configured to form an image on a recording medium based on the image of the document read by the reading unit,
wherein, when the controller stops feeding of the document based on the detection sensor, (a) in a case where the environment information acquired by the environment sensor satisfies a predetermined condition, the display displays a screen for prompting a user to loosen a bundle of documents, and (b) in a case where the environment information acquired by the environment sensor does not satisfy the predetermined condition, the display does not display the screen for prompting the user to loosen the bundle of documents.

15. The image forming apparatus according to claim 14,
wherein the environment sensor is arranged on the apparatus main body, and
wherein the image forming unit controls an image forming condition to be applied when the image is formed on the recording medium based on the environment information acquired by the environment sensor.
